(19) United States
(12) Patent Application Publication
(10) Pub. No.: US 2012/0145140 A1
(43) Pub. Date: Jun. 14, 2012

(54) TURBO OVEN CAPABLE OF STIRRING AND TURNING FOOD MATERIALS

(75) Inventor: Kuei-Tang CHANG, Banchiau City (TW)

(73) Assignee: Tall & Stout Industrial Corp.

(21) Appl. No.: 12/966,016

(22) Filed: Dec. 13, 2010

(51) Int. Cl. A21B 1/00

(52) U.S. Cl. 126/19 R

(57) ABSTRACT

A turbo oven includes a cover having an activating assembly and an oven body for containing food materials. The oven body includes a pot assembly, a stirring assembly and a stopping element. The pot assembly is configured to support the cover and contain the food materials. The stirring assembly is disposed in the pot assembly. The stirring assembly includes a shaft rod and a stirring blade connected to the shaft rod. The shaft rod is driven by the activating assembly for rotation. The rotation of the shaft rod drives the stirring blade to rotate in the pot assembly. The stopping element is connected to the inner wall of the pot assembly and protrudes from the inner wall of the pot assembly. By this structure, the food materials received in the pot assembly can be cooked thoroughly and uniformly.

### BACKGROUND OF THE INVENTION

1. Field of the Invention

The present invention relates to a turbo oven, in particular to a turbo oven capable of cooking food materials uniformly.

2. Description of Prior Art

When using a turbo oven for cooking, the user only needs little oil to cook food materials, and only little smoke is generated during the cooking On the other hand, cooking by the turbo oven may not change food structure or generate hazardous materials, so that the food materials cooked by the turbo oven are juicy and tasty. Thus, the turbo oven has become more and more popular recently. The existing turbo oven available in the market includes a pot assembly, a cover covering the pod assembly, and a heater provided on the cover. With this arrangement, hot air generated by the heater is blown into the pot assembly to thereby cook the food materials received in the pot assembly.

However, in practice, the above-mentioned turbo oven has the following problems. When the user intends to cook potato strips, corn seeds or other small-sized food materials, since these small-sized food materials stack up in the pot assembly, only an outer portion of these small-sized food materials can be cooked thoroughly by the hot air. Thus, if the food materials are not stirred sufficiently during the cooking, the inner portion of the food materials may not be cooked thoroughly by the hot air. On the other hand, the user has to stir the food materials by hand frequently to make sure that the food materials are cooked thoroughly and uniformly, which is time-consuming, laborious and inconvenient for the user.

In order to solve the above-mentioned problems, the present Inventor proposes a novel and reasonable structure based on his expert knowledge and deliberate researches

### SUMMARY OF THE INVENTION

The present invention is to provide a turbo oven capable of stirring and turning food materials, whereby the food materials can be cooked thoroughly and uniformly.

The present invention provides a turbo oven capable of stirring and turning food materials, including a cover having an activating assembly and a oven body for containing the food materials. The oven body includes a pot assembly, a stirring assembly and a stopping element. The pot assembly is configured to support the cover and contain the food materials. The stirring assembly is disposed in the pot assembly and comprises a shaft rod and a stirring blade connected to the shaft rod. The shaft rod is driven by the activating assembly for rotation. The rotation of the shaft rod drives the stirring blade to rotate in the pot assembly. The stopping element is connected to an inner wall of the pot assembly and protrudes from the inner wall of the pot assembly.

In comparison with prior art, the interior of the turbo oven of the present invention is arranged with the stirring assembly, and the stopping element is provided on the inner wall of the pot assembly. When the turbo oven is in operation, the stopping element exerts a force to the food materials pushed by the stirring assembly, thereby turning the food materials. In this way, the food materials can be cooked more thoroughly and uniformly. Unlike the conventional turbo oven unable to stir the food materials, the present invention is more practicable and convenient.

### BRIEF DESCRIPTION OF DRAWING

FIG. 1 is a perspective view showing the external appearance of the turbo oven of the present invention;

FIG. 1A is an enlarged view showing the portion A in FIG. 1;

FIG. 2 is an assembled cross-sectional view showing the turbo oven of the present invention;

FIG. 3 is a perspective view showing the external appearance of the inner pot of the present invention;

FIG. 4 is a schematic view showing the operation of the stirring assembly of the present invention; and

FIG. 5 is a schematic view showing the operation of the present invention for turning the food materials.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

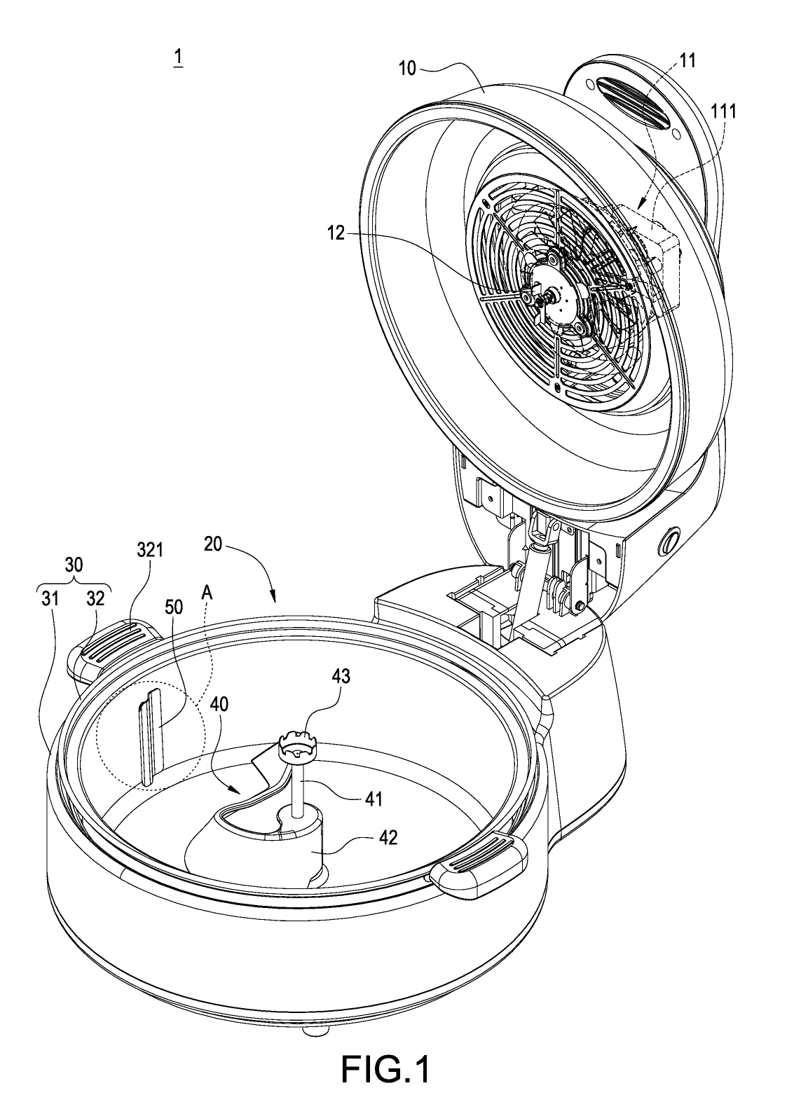

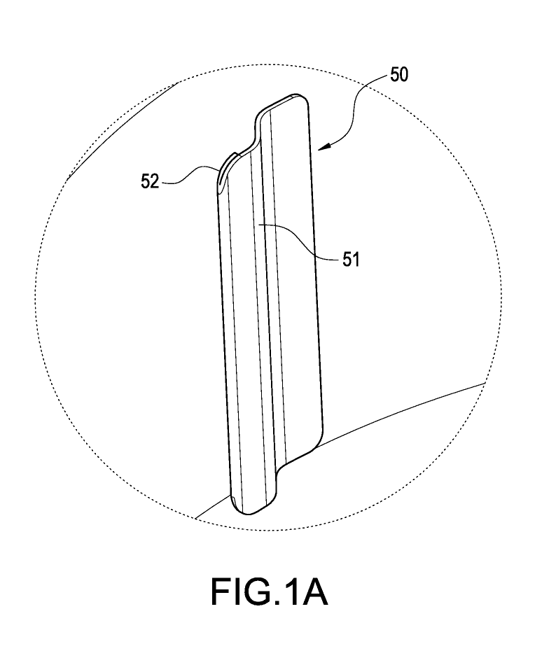

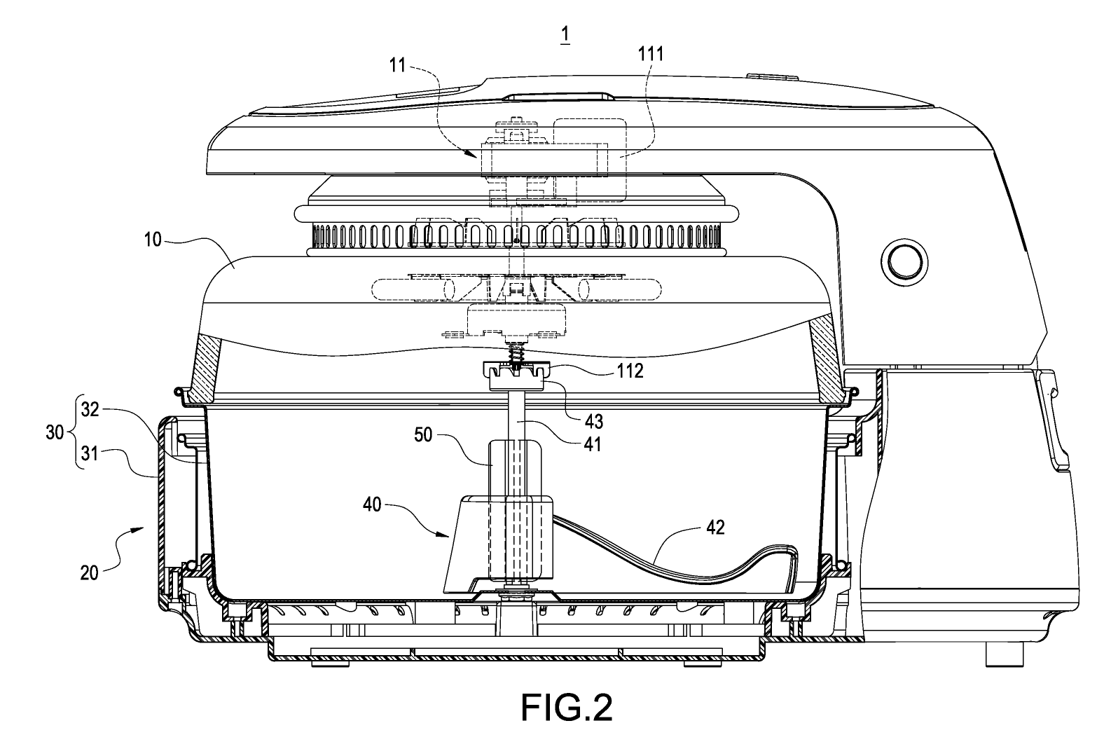

Please refer to FIGS. 1 and 2. FIG. 1 is a perspective view showing the external appearance of the turbo oven of the present invention, and FIG. 2 is an assembled cross-sectional view showing the turbo oven of the present invention. The present invention provides a turbo oven 1 capable of stirring and turning food materials, which includes a cover 10 and a oven body 20. The cover 10 has an activating assembly 11. The oven body 20 includes a pot assembly 30, a stirring assembly 40 and a stopping element 50.

The pot assembly 30 is configured to support the cover 10 and contain the food materials to be cooked. In the present embodiment, the pot assembly 30 comprises an outer pot 31 and an inner pot 32 received in the outer pot 31. The top of the inner pot 32 is provided with a pair of grips 321

The stirring assembly 40 is disposed in the pot assembly 30. The stirring assembly 40 comprises a shaft rod 41 and a stirring blade 42 connected to the shaft rod 41. The shaft rod 41 is driven by the activating assembly 11 for rotation. The rotation of the shaft rod 11 drives the stirring blade 42 to rotate in the pot assembly 30 (inner pot 32).

More specifically, the activating assembly 11 comprises an activator 111 and an engaging plate 112 connected to the activator 111. The stirring assembly 40 further comprises a connecting ring 43 connected to the free end of the shaft rod 41. The engaging plate 112 is engaged with the connecting ring 42 to drive the shaft rod 41 for rotation.

The stopping element 50 is connected to an inner wall of the pot assembly 30. More specifically, the stopping element 50 protrudes from the inner wall of the pot assembly 30. The length of the stopping element 50 may be varied according to practical demands. The stopping element 50 may be integrally formed with the pot assembly 30 (inner pot 32) or provided on the inner wall of the pot assembly 30 separately. The stopping element 50 may be combined with the pot assembly 30 by a soldering process or screws. In the present embodiment, the stopping element 50 is connected to the inner wall of the inner pot 32 in such a manner that the stopping element 50 protrudes from the bottom toward the top of the inner pot 32. Moreover, the stopping element 50 is formed into a bent piece having a N-shaped cross section. However, it should be understood that the profile or the cross section of the stopping element 50 is not limited thereto.

Please refer to FIG. 1A, which is an enlarged view of the portion A in FIG. 1. In the present embodiment, the stopping element 50 has a bent surface 51 facing the interior of the pot assembly 30. The bent surface 51 is formed with a round fillet. On side of the stopping element 50 protruding from the inner pot 32 is bent to form a fold 52 abutting against the back surface of the stopping element 50 facing the inner pot 32. With the bent surface 51 and the fold 52, the food materials may not suffer damage due to the sharp edge of the stopping element 50 when they are stirred in the pot assembly 30.

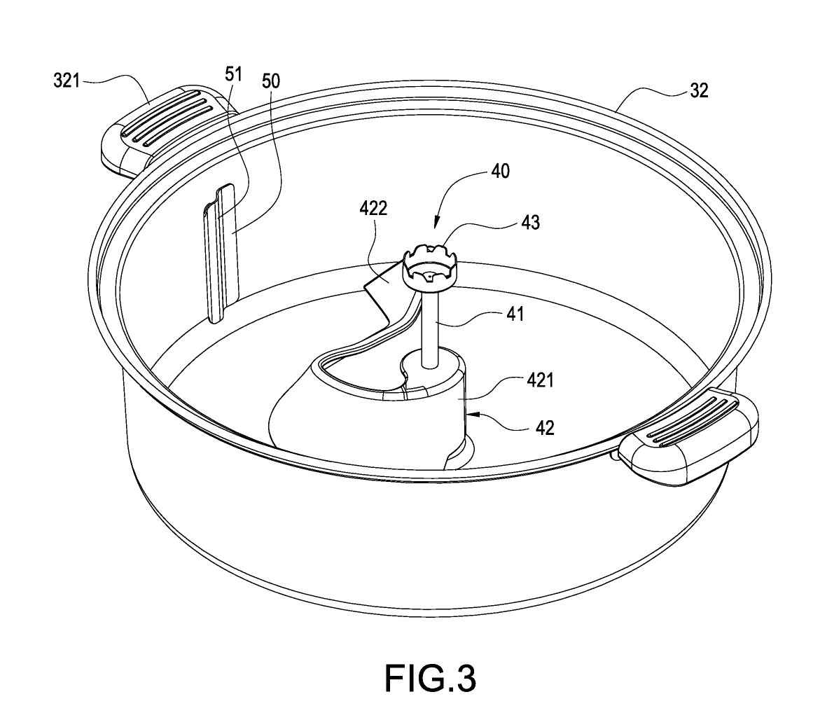

Please refer to FIG. 3, which is a schematic view showing the external appearance of the inner pot 32 of the present invention. The stirring assembly 40 is disposed in the inner pot 32. The stirring blade 42 comprises a base 421 fixed onto the shaft rod 41 and a blade 422 extending outwards from the base 421. The blade 422 is bent into a curved shape. When the stirring blade 42 is in operation, a gap is maintained between the distal end of the blade 422 and the stopping element 50.

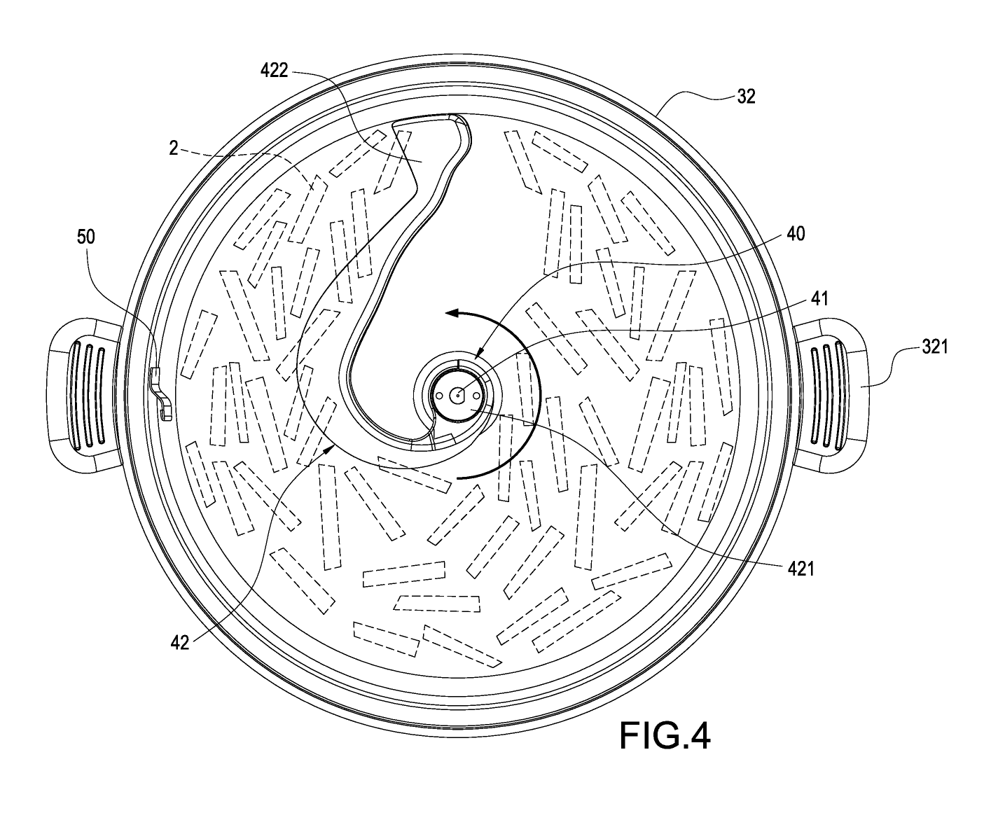

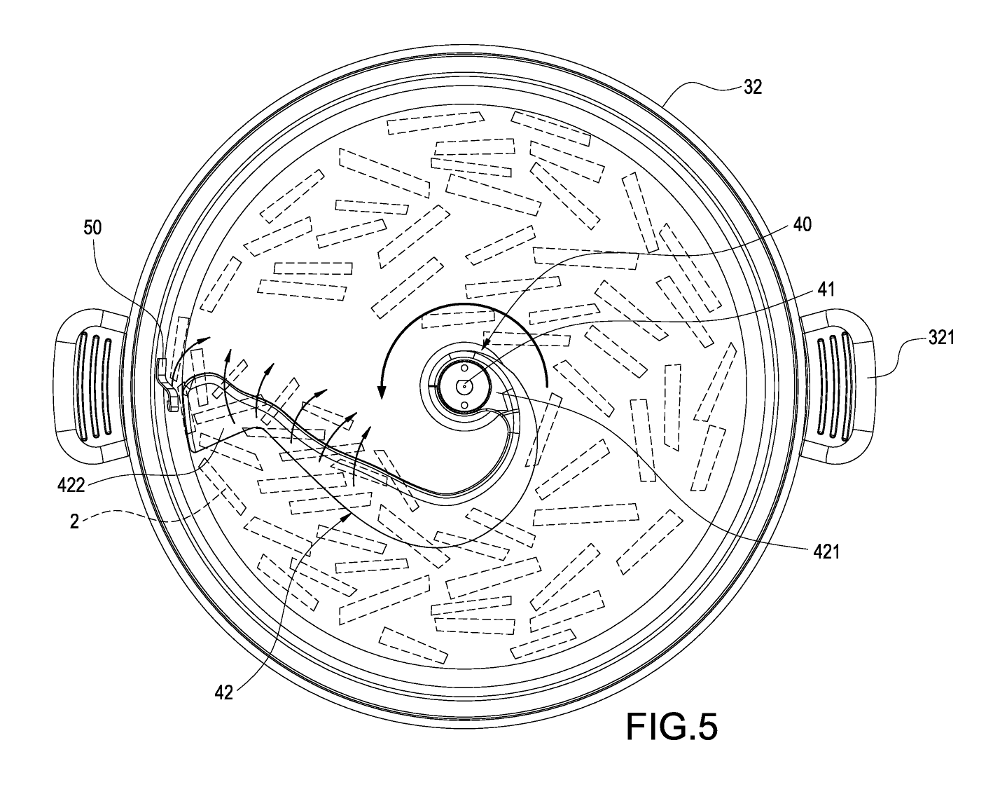

Please refer to FIGS. 4 and 5. FIG. 4 is a schematic view showing the operation of the stirring assembly of the present invention, and FIG. 5 is a schematic view showing the operation of the present invention for turning the food materials. When the turbo oven 1 of the present invention is in operation, the food materials 2 to be cooked (such as potato stripes) are disposed into the inner pot 32. In order to show the stirring operation more clearly, the cover 10 of the turbo oven 1 is not depicted for clarity. In practice, the cover 10 needs to cover on the pot assembly 30 because the cover 10 is provided with a heater (not shown) for generating hot air to cook the food materials 2. After the cover 10 covers on the pot assembly 30, the turbo oven 1 is activated, and then the stirring assembly 40 starts to rotate. As a result, the blade 422 rotates in the pot assembly 30 to push the food materials 2 to circulate in the pot assembly 30, whereby the food materials 2 can be cooked uniformly. When the food materials 2 are pushed to contact the stopping element 50. The stopping element 50 exerts a force to the food materials 2 pushed by the blade 422, so that the food materials 2 turn over the blade 422. In this way, the food materials 2 can be cooked more thoroughly and uniformly.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A turbo oven capable of stirring and turning food materials, the turbo oven comprising a cover having an activating assembly and an oven body for containing the food materials, the oven body including:
a pot assembly configured to support the cover and contain the food materials;
a stirring assembly disposed in the pot assembly, the stirring assembly comprising a shaft rod and a stirring blade connected to the shaft rod, the shaft rod being driven by the activating assembly for rotation, the rotation of the shaft rod driving the stirring blade in the pot assembly for rotation; and
a stopping element connected to an inner wall of the pot assembly and protruding from the inner wall of the pot assembly.

2. The turbo oven capable of stirring and turning food materials according to claim 1, wherein the pot assembly comprises an outer pot and an inner pot received in the outer pot, the stirring assembly is disposed in the inner pot.

3. The turbo oven capable of stirring and turning food materials according to claim 1, wherein the inner pot has a pair of grips.

4. The turbo oven capable of stirring and turning food materials according to claim 1, wherein the activating assembly comprises an activator and an engaging plate connected to the activator, the stirring assembly further comprises a connecting ring connected to the shaft rod, the engaging plate is engaged with the connecting ring to drive the shaft rod for rotation.

5. The turbo oven capable of stirring and turning food materials according to claim 1, wherein the stirring blade comprises a base fixed onto the shaft rod and a blade extending outwards from the base.

6. The turbo oven capable of stirring and turning food materials according to claim 5, wherein the blade is bent to extend outwards, and a gap is maintained between a distal end of the blade and the stopping element.

7. The turbo oven capable of stirring and turning food materials according to claim 2, wherein the stopping element is connected to the inner wall of the inner pot.

8. The turbo oven capable of stirring and turning food materials according to claim 7, wherein the stopping element protrudes from a bottom edge of the inner pot in a direction away from the inner wall of the pot assembly.

9. The turbo oven capable of stirring and turning food materials according to claim 1, wherein the stopping element is a bent piece having a N-shaped cross section.

10. The turbo oven capable of stirring and turning food materials according to claim 9, wherein the stopping element has a bent surface oriented toward the interior of the pot assembly, the bent surface is formed with a round fillet.

11. The turbo oven capable of stirring and turning food materials according to claim 9, wherein one side of the stopping element is bent to form a fold abutting against a back surface of the stopping element facing the inner pot.

12. The turbo oven capable of stirring and turning food materials according to claim 1, wherein the stopping element is integrally formed with the pot assembly.
